(19) United States
(12) Patent Application Publication
(10) Pub. No.: US 2026/0220850 A1
(43) Pub. Date: Jul. 30, 2026

(54) TRAINING A DIFFUSION MODEL FOR GENERATING SYNTHESIZED IMAGES

(71) Applicant: Bytedance Technology Ltd., Grand Cayman (KY)

(72) Inventors: Liming Jiang, Los Angeles, CA (US); Qing Yan, Los Angeles, CA (US); Zichuan Liu, Los Angeles, CA (US); Xin Lu, Los Angeles, CA (US); Yumin Jia, Los Angeles, CA (US)

(21) Appl. No.: 19/190,029

(22) Filed: Apr. 25, 2025

Related U.S. Application Data
(60) Provisional application No. 63/749,349, filed on Jan. 24, 2025.

(51) Int. Cl. G06T 11/60; G06T 5/70

(52) U.S. Cl. CPC G06T 11/60; G06T 5/70; G06T 2207/20182; G06T 2207/30168

(57) ABSTRACT

A computing method is provided for training an untrained diffusion model to generate a synthesized image based on an input prompt and an input image, including collecting real single-person-single-view (SPSV) images to input into the untrained diffusion model, training it in a reverse process to predict a denoised version of the SPSV images by minimizing a loss between the reconstructed images and the SPSV images, and adjusting weights to generate a trained first stage model. Then synthetic single-person-multi-view (SPMV) images are generated using the trained first stage model. The computing method further includes inputting each SPSV image into the trained first stage model, training it in a reverse process to predict a denoised version of the SPSV image, using the synthetic SPMV images as a target image by minimizing a loss between the reconstructed image and the target image, and adjusting weights to generate a trained second stage model.

### CROSS REFERENCE TO RELATED APPLICATION

This application claims priority to U.S. Provisional Patent Application Ser. No. 63/749,349, filed Jan. 24, 2025, the entirety of which is hereby incorporated herein by reference for all purposes.

### BACKGROUND

Diffusion models are a class of probabilistic generative models that typically involve two stages: a forward diffusion stage and a reverse denoising stage. In the forward diffusion process, input data is gradually altered and degraded over multiple iterations by adding noise at different scales. In the reverse denoising process, the model learns to reverse the diffusion noising process, iteratively refining an initial image, typically made of random noise, into a fine-grained colorful synthesized image.

Recently, conventional diffusion models have been developed that take as input a text input, image input (e.g., pose image, background image, etc.), or other modes of input, and generate an output image based on the input(s). However, these conventional diffusion models face significant limitations, particularly when tasked with generating images of a known individual. For example, these models often fail to preserve fine-grained identity characteristics of the known individuals in the input images.

To address this challenge, ID injection modules have been introduced as a way to inject identity features from reference images of known individuals into the generative process of diffusion models. Diffusion models with ID injection modules have been applied to generate personalized avatars, facial images with added effects, stylized images of the person, etc. These ID injection modules extract identity-specific features from a reference identification image and inject them into the diffusion model at various stages, enabling the model to generate images that reflect the identity of a specific individual. While ID injection helps personalize synthesized images, existing training methods for these modules suffer from several drawbacks, including low aesthetic quality and style discrepancies.

### SUMMARY

In view of the above issues, a computing method is provided for training an untrained diffusion model to generate a synthesized image based on an input prompt and an input image. The computing method includes collecting real single-person-single-view (SPSV) images, inputting each SPSV image into the untrained diffusion model, corrupting the SPSV image through a forward process by adding noise, training the untrained diffusion model in a reverse process to predict a denoised version of the SPSV images and generate reconstructed images by minimizing a loss between the reconstructed images and the SPSV images, and adjusting weights of the untrained diffusion model based on the minimized loss to generate a trained first stage model. Then synthetic single-person-multi-view (SPMV) images are generated using the trained first stage model. The computing method further includes inputting each SPSV image into the trained first stage model, corrupting the SPSV image through a forward process by adding noise, training the first stage model in a reverse process to predict a denoised version of the SPSV image and generate a reconstructed image, using the synthetic SPMV images as a target image by minimizing a loss between the reconstructed image and the target image, and adjusting weights of the first stage model to generate a trained second stage model.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic view of a training computing system and an inference computing system according to an example of the present disclosure.

FIG. 2 illustrates a detailed schematic view of the inference computing system of FIG. 1.

FIG. 3 illustrates a detailed schematic view of the data distillation and model distillation module of the training computing system of FIG. 1.

FIG. 4 is a flowchart of a method for training an untrained diffusion model to generate a synthesized image based on an input prompt and an input image according to an example embodiment of the present disclosure.

FIG. 5 shows an example computing environment of the present disclosure.

### DETAILED DESCRIPTION

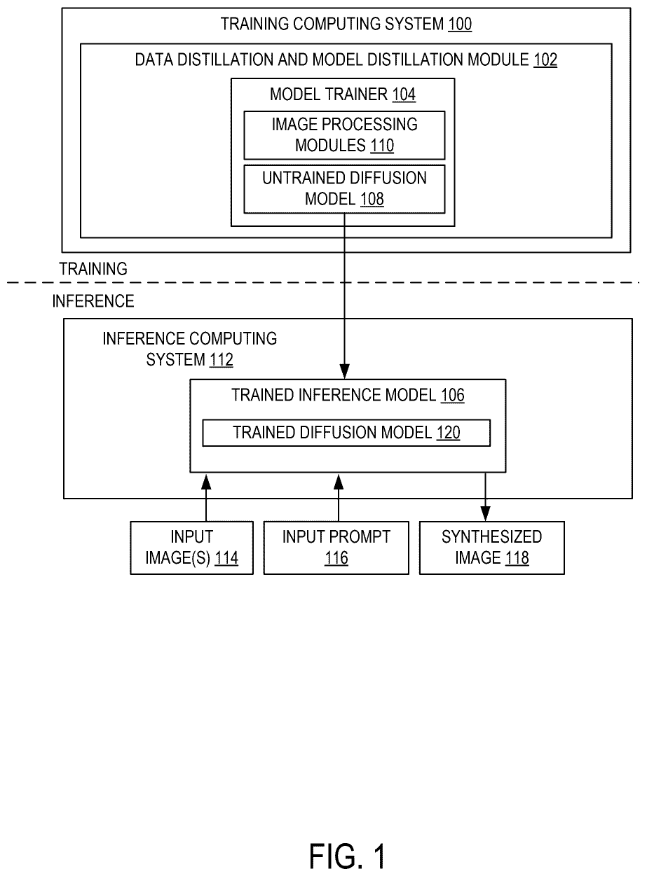

Referring to FIG. 1, a process of generating a synthesized image 118 using a facial feature injection and diffusion process is schematically depicted from the training steps to the inference steps. Initially, a training computing system 100 executes a data distillation and model distillation module 102, which includes a model trainer 104 configured to train an untrained diffusion model 108 using training data and image processing modules 110. The diffusion model 120 trained by the model trainer 104 is then installed on an inference computing system 112 in a trained inference model 106, which receives one or more input images 114 and an input prompt 116. For example, the input image 114 may depict a known individual and the input prompt 116 may describe one or more desired attributes of a target image. Responsive to receiving the one or more input images 114 and the input prompt 116, the trained inference model 106 processes the one or more input images 114 and the input prompt 116 to generate a synthesized image 118 with content in alignment with the one or more input images 114 and the input prompt 116, as explained in further detail below. The synthesized image 118 may preserve identity-specific features of the known individual while reflecting the one or more desired attributes of the target image.

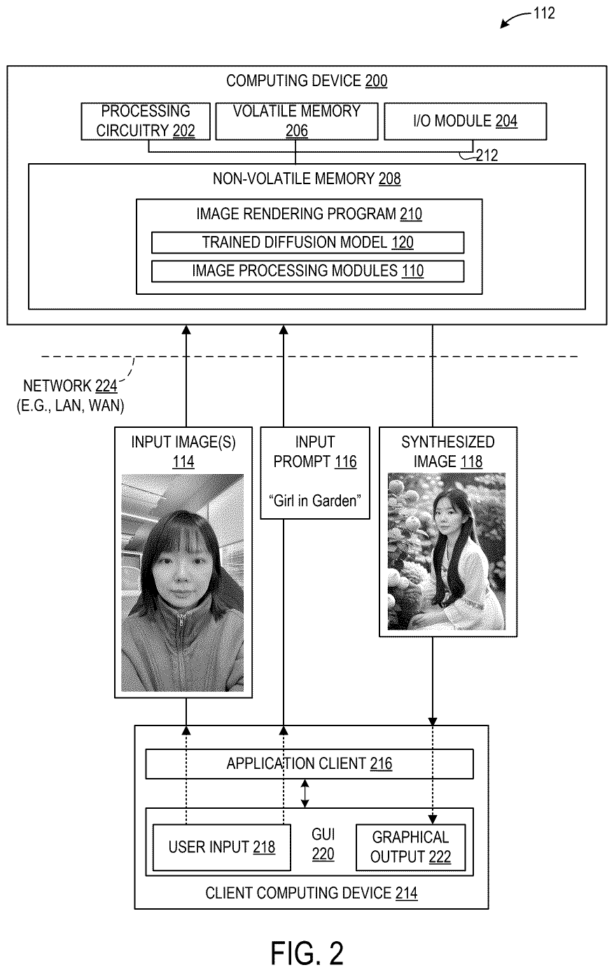

Referring to FIG. 2, an inference computing system 112 for generating a synthesized image using a facial feature injection and diffusion process is provided. The inference computing system 112 comprises a computing device 200 including processing circuitry 202, an input/output module 204, volatile memory 206, and non-volatile memory 208 storing an image rendering program 210 comprising a trained diffusion model 120 and image processing modules 110. A bus 212 may operatively couple the processing circuitry 202, the input/output module 204, and the volatile memory 206 to the non-volatile memory 208. The inference computing system 112 is operatively coupled to a client computing device 214 via a network 224. In some examples, the network 224 may take the form of a local area network (LAN), wide area network (WAN), wired network, wireless network, personal area network, or a combination thereof, and can include the Internet. Although the image rendering program 210 is depicted as hosted at one computing device 200, it will be appreciated that the image rendering program 210 may alternatively be hosted across a plurality of computing devices to which the computing device 200 may be communicatively coupled via a network, including network 224.

The processing circuitry 202 is configured to store the image rendering program 210 in non-volatile memory 208 that retains instructions stored data even in the absence of externally applied power, such as FLASH memory, a hard disk, read only memory (ROM), electrically erasable programmable memory (EEPROM), etc. The instructions include one or more programs, including the image rendering program 210, and data used by such programs sufficient to perform the operations described herein. In response to execution by the processing circuitry 202, the instructions cause the processing circuitry 202 to execute the image rendering program 210, which includes the trained diffusion model 120 and the image processing modules 110.

The processing circuitry 202 is a microprocessor that includes one or more of a central processing unit (CPU), a graphical processing unit (GPU), an application specific integrated circuit (ASIC), a system on chip (SOC), a field-programmable gate array (FPGA), a logic circuit, or other suitable type of microprocessor configured to perform the functions recited herein. Volatile memory 206 can include physical devices such as random access memory (RAM), static random access memory (SRAM), dynamic random access memory (DRAM), etc., which temporarily stores data only for so long as power is applied during execution of programs. Non-volatile memory 208 can include physical devices that are removable and/or built in, such as optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology.

In one example, a user operating the client computing device 214 may send one or more input images 114 and an input prompt 116 to the computing device 200. In this example, the input image 114 is a portrait of a young woman, and the input prompt 116 is “girl in garden”. The processing circuitry 202 of the computing device 200 is configured to receive the one or more input images 114 and the input prompt 116 from the user and execute the image rendering program 210 including the trained diffusion model 120 and the image processing modules 110 to generate a synthesized image 118 with content that corresponds to the one or more input images 114 and the input prompt 116. In this example, the synthesized image 118 is a stylized perspective portrait of a girl in a garden which preserves the identity of the young woman in the input image 114 and aligns with the input prompt 116 indicating a “girl in garden”. The processing circuitry 202 then returns the synthesized image 118 to the client computing device 214.

The client computing device 214 may execute an application client 216 to send the one or more input images 114 and the input prompt 116 to the computing device 200 upon detecting a user input 218 and subsequently receive the synthesized image 118 from the computing device 200. The application client 216 may be coupled to a graphical user interface 220 of the client computing device 214 to display a graphical output 222 of the synthesized image 118.

Although not depicted here, it will be appreciated that the training computing system 100 that executes the data distillation and model distillation module 102 of FIG. 1 can be configured similarly to computing device 200.

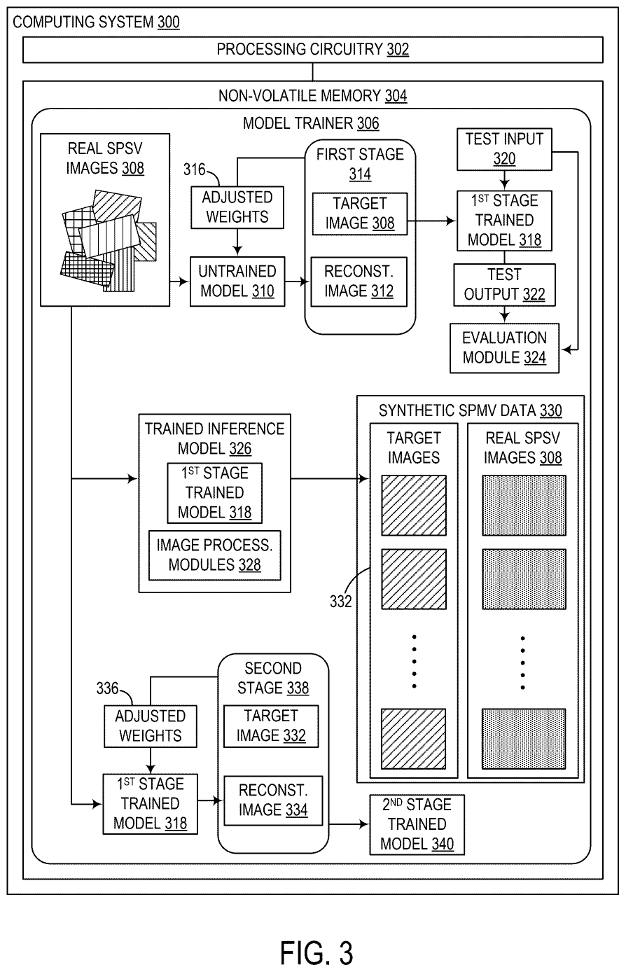

FIG. 3 shows a schematic view of a second example computing system 300 instantiating a model trainer 306 for the training of a first stage model 318 and a second stage model 340 that are configured with the same architecture as the trained diffusion model 120 described in FIG. 2. The computing system 300 includes processing circuitry 302 (e.g., central processing units, or “CPUs”) and non-volatile memory 304 which stores instructions to execute a model trainer 306 to train the first stage model 318 and the second stage model 340.

Real single-person-single-view (SPSV) images 308 are collected and filtered from several human portrait datasets and used as source images. In a first stage 314 of training, each SPSV image 308 is inputted into an untrained model 310, which gradually corrupts the source image 308 through the addition of noise in a forward process. In the reverse process, the untrained model 310 is trained to predict the denoised version of the source image 308 at each step of the reverse process and generate a reconstructed image 312 by minimizing the loss between the reconstructed image 312 that is outputted by the untrained model 310 and the target image 308. In this example, the target image 308 is configured to be identical to the source image 308. The weights 316 of the untrained model 310 are adjusted based on the calculated losses to generate a trained first stage model 318.

Following the training of the untrained model 310 to generate the trained first stage model 318, model inference may be performed to evaluate the image generation performance of the trained first stage model 318. A test input 320 is inputted into the trained first stage model 318 to generate test output 322. An evaluation module 324 receives the test input 320 and test output 322 to evaluate the performance of the trained first stage model 318 through the image quality or reconstruction quality of the test output 322. For example, image quality or reconstruction quality may be measured using objective metrics such as Peak Signal-to-Noise Ratio (PSNR), which measures the pixel-level similarity between the generated image and the synthetic target image (if available). Higher PSNR indicates higher reconstruction quality. Image quality or reconstruction quality may also be measured using a Structural Similarity Index (SSIM), which evaluates perceptual quality by measuring structural similarity between the generated and target images, and Frechet Inception Distance (FID), which measures the similarity of the distributions of generated images and real-world images. Lower FID indicates higher image realism. The evaluation module 324 may measure identity similarity between the test input 320 and test output 322 as a measure of reconstruction quality. Identity similarity may be measured using cosine similarity or Euclidian distance, for example. When at least one objective metric indicates an image quality or reconstruction quality below a predetermined threshold, one or more parameters of the trained first stage model 318 may be adjusted.

A trained inference model 326 comprising the trained first stage model 318 and image processing modules 328 is used to generate synthetic single-person-multi-view (SPMV) images 330, including a plurality of target images 332, based on the real SPSV images 308. These image processing modules 328 may use various image processing techniques in conjunction with the trained first stage model 318. For example, latent space manipulation may be used to synthesize target images 332 depicting a person in different poses (side views, top-down views, for example), varying expressions (smiling, frowning, for example), and diverse lighting conditions. Face swap techniques may be used to transfer the facial identity learned by the trained first stage model 318 onto target images 332 with different poses or scenes. Specific weights of the trained first stage model 318 may be modified by LoRA (Low-Rank Adaptation). The synthetic SPMV images 330 may be formulated as pairs of source images 308 and target images 332 generated based on the source images 308.

During the training of the second stage model 340 in a second stage 338 of training, each SPSV image 308 is inputted into the trained first stage model 318, which gradually corrupts the source image 308 through the addition of noise in a forward process. In the reverse process, the untrained model 310 is trained to predict the denoised version of the source image 308 at each step of the reverse process and generate a reconstructed image 334 by minimizing the loss between the reconstructed image 334 that is outputted by the trained first stage model 318 and the target image 332 in the synthetic SPMV images 330. The weights 336 of the trained first stage model 318 are adjusted based on the calculated losses to generate a trained second stage model 340.

The target images 332 may include the face of the subject in the source images 308 depicted in different poses, expressions, and lighting conditions. Accordingly, the second stage 338 of training ensures that the trained model 340 can consistently maintain the facial features of the source image 308 in the reconstructed image 334, while allowing the trained model 340 to synthesize realistic images of the subject under conditions not present in the real source images 308, such as different poses, expressions, and lighting conditions. In other words, the trained second stage model 340 is trained to reverse the noise in the denoising process and reconstruct the synthetic target images 332 by learning to map real identities to their corresponding multi-view representations.

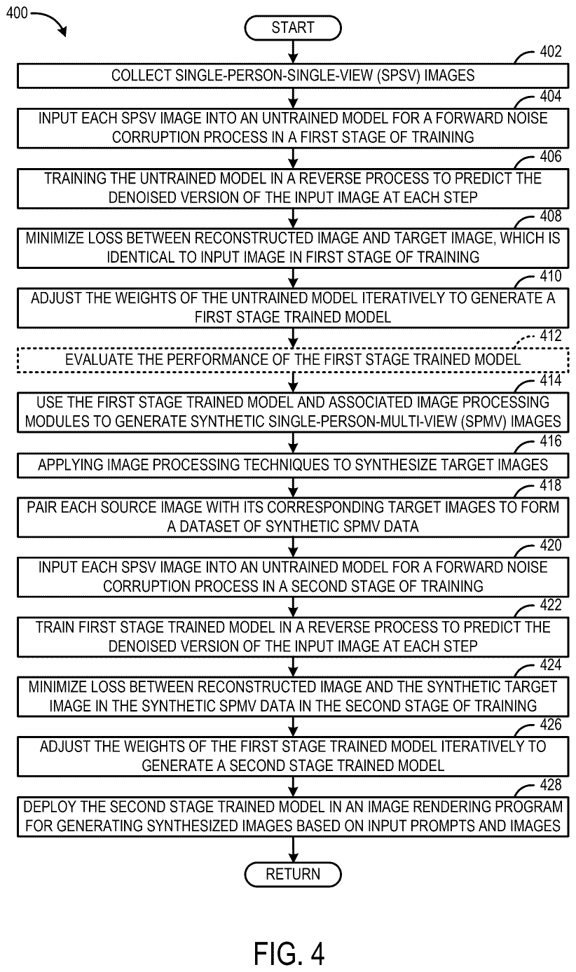

FIG. 4 shows a process flow diagram of an example method 400 for generating a synthesized image. The example method 400 may be executed by the processing circuitry and memory of the training computing system 100 of FIG. 1. The example method 400 includes, at step 402, collecting real single-person-single-view (SPSV) images from various human portrait datasets. The method 400 includes, at step 404, inputting each SPSV image into an untrained model for a forward noise corruption process in a first stage of training. At step 406, the method 400 includes training the untrained model in a reverse process to predict the denoised version of the input image at each step. At step 408, the method 400 includes generating reconstructed images by minimizing the loss between the reconstructed image and the target image, which is identical to the input image in the first stage of training. At step 410, the method 400 includes adjusting the weights of the untrained model iteratively to generate a trained first stage model.

The method 400 may include, at step 412, evaluating the performance of the trained first stage model by performing model inference, inputting a test image into the trained first stage model to generate a test output for evaluation.

The method 400 includes, at step 414, using the trained first stage model and associated image processing modules to generate synthetic single-person-multi-view (SPMV) data. At step 416, the method 400 includes applying image processing techniques to synthesize target images with diverse poses, expressions, and lighting conditions. At step 418, the method 400 includes pairing each source image with its corresponding target images to form a dataset of synthetic SPMV data.

At step 420, the method 400 includes inputting each SPSV image into the trained first stage model for a forward noise corruption process in a second stage of training. At step 422, the method 400 includes training the trained first stage model in a reverse process to predict the denoised version of the input image at each step. At step 424, the method 400 includes generating reconstructed images by minimizing the loss between the reconstructed image and the synthetic target image in the synthetic SPMV data in the second stage of training. At step 426, the method 400 includes adjusting the weights of the trained first stage model iteratively to generate a trained second stage model.

At step 428, the method 400 includes deploying the trained second stage model in an image rendering program for generating synthesized images based on input prompts and images.

As described throughout herein, by implementing a multi-stage training process for the diffusion model, significant technical benefits are achieved, including enhanced accuracy, scalability, and versatility in image generation, so that images containing a target individual can be synthesized with a diffusion model to consistently maintain the identity of the target individual in the synthesized image while preserving aesthetic and stylistic consistency as well as minimizing artifacts and stylistic distortions.

In some embodiments, the methods and processes described herein may be tied to a computing system of one or more computing devices. In particular, such methods and processes may be implemented as a computer-application program or service, an Application Program Interface (API), a library, and/or other computer-program product. In some embodiments, the methods and processes described herein may be tied to a computing system of one or more computing devices. In particular, such methods and processes may be implemented as a computer-application program or service, an API, a library, and/or other computer-program product.

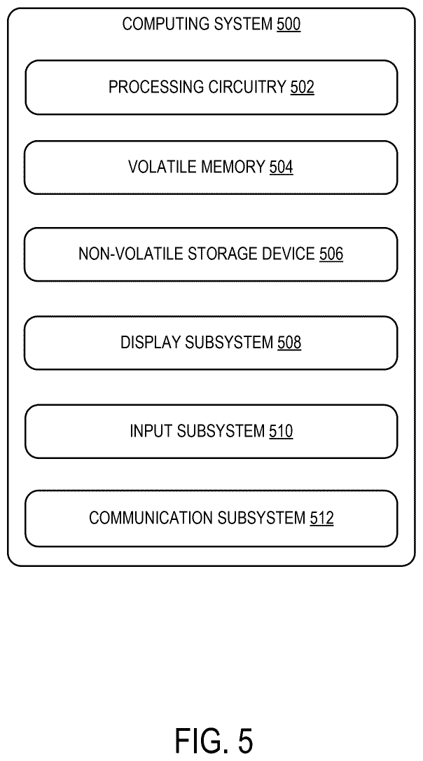

FIG. 5 schematically shows a non-limiting embodiment of a computing system 500 that can enact one or more of the methods and processes described above. Computing system 500 is shown in simplified form. Computing system 500 may embody the training computing system 100 described above and illustrated in FIG. 1, the computing device 200 and client computing device 214 described above and illustrated in FIG. 2, or the computing system 300 described above and illustrated in FIG. 3. Components of computing system 500 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 500 includes processing circuitry 502, volatile memory 504, and a non-volatile storage device 506. Computing system 500 may optionally include a display subsystem 508, input subsystem 510, communication subsystem 512, and/or other components not shown in FIG. 5.

Processing circuitry 502 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 502 may be single-core or multi-core, and the instructions executed thereon may be configured for sequential, parallel, and/or distributed processing. Individual components of the processing circuitry 502 optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 502.

Non-volatile storage device 506 includes one or more physical devices configured to hold instructions executable by the processing circuitry 502 to implement the methods and processes described herein. When such methods and processes are implemented, the state of non-volatile storage device 506 may be transformed—e.g., to hold different data.

Non-volatile storage device 506 may include physical devices that are removable and/or built in. Non-volatile storage device 506 may include optical memory, semiconductor memory, and/or magnetic memory, or other mass storage device technology. Non-volatile storage device 506 may include nonvolatile, dynamic, static, read/write, read-only, sequential-access, location-addressable, file-addressable, and/or content-addressable devices. It will be appreciated that non-volatile storage device 506 is configured to hold instructions even when power is cut to the non-volatile storage device 506.

Volatile memory 504 may include physical devices that include random access memory. Volatile memory 504 is typically utilized by processing circuitry 502 to temporarily store information during processing of software instructions. It will be appreciated that volatile memory 504 typically does not continue to store instructions when power is cut to the volatile memory 504.

Aspects of processing circuitry 502, volatile memory 504, and non-volatile storage device 506 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 500 typically implemented in software by a processor to perform a particular function using portions of volatile memory, which function involves transformative processing that specially configures the processor to perform the function. Thus, a module, program, or engine may be instantiated via processing circuitry 502 executing instructions held by non-volatile storage device 506, using portions of volatile memory 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 508 may be used to present a visual representation of data held by non-volatile storage device 506. The visual representation may take the form of a graphical user interface (GUI). As the herein described methods and processes change the data held by the non-volatile storage device, and thus transform the state of the non-volatile storage device, the state of display subsystem 508 may likewise be transformed to visually represent changes in the underlying data. Display subsystem 508 may include one or more display devices utilizing virtually any type of technology. Such display devices may be combined with processing circuitry 502, volatile memory 504, and/or non-volatile storage device 506 in a shared enclosure, or such display devices may be peripheral display devices.

When included, input subsystem 510 may comprise or interface with one or more user-input devices such as a keyboard, mouse, touch screen, camera, or microphone.

When included, communication subsystem 512 may be configured to communicatively couple various computing devices described herein with each other, and with other devices. Communication subsystem 512 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 500 to send and/or receive messages to and/or from other devices via a network such as the Internet.

The following paragraphs provide additional description of the subject matter of the present disclosure. One aspect provides a computing method for training an untrained diffusion model to generate a synthesized image based on an input prompt and an input image, comprising collecting real single-person-single-view (SPSV) images, inputting each SPSV image into the untrained diffusion model, corrupting the SPSV image through a forward process by adding noise, training the untrained diffusion model in a reverse process to predict a denoised version of the SPSV images and generate reconstructed images by minimizing a loss between the reconstructed images and the SPSV images, adjusting weights of the untrained diffusion model based on the minimized loss to generate a trained first stage model, generating synthetic single-person-multi-view (SPMV) images using the trained first stage model, inputting each SPSV image into the trained first stage model, corrupting the SPSV image through a forward process by adding noise, training the first stage model in a reverse process to predict a denoised version of the SPSV image and generate a reconstructed image, using the synthetic SPMV images as a target image by minimizing a loss between the reconstructed image and the target image, and adjusting weights of the first stage model to generate a trained second stage model. In this aspect, additionally or alternatively, generating the synthetic SPMV images may comprise using the trained first stage model and image processing modules to generate a plurality of target images based on the real SPSV images. In this aspect, additionally or alternatively, generating the synthetic SPMV images may comprise using latent space manipulation to synthesize target images with varied poses and expressions. In this aspect, additionally or alternatively, generating the synthetic SPMV images may comprise using face swap techniques to transfer facial identity from the SPSV images to target images with different poses or scenes. In this aspect, additionally or alternatively, generating the synthetic SPMV images may comprise modifying weights of the first stage model using Low-Rank Adaptation (LoRA). In this aspect, additionally or alternatively, the synthetic SPMV images may be paired with corresponding SPSV images to form a dataset. In this aspect, additionally or alternatively, the computing method may further comprise deploying the trained second stage model to generate synthesized images, wherein the synthesized images maintain identity consistency of the input image while reflecting different poses, expressions, and lighting conditions. In this aspect, additionally or alternatively, the method may further comprise inputting test input into the trained first stage model to generate test output, evaluating an identity similarity between the test input and the test output, and adjusting one or more parameters of the trained first stage model when the identity similarity is below a predetermined threshold. In this aspect, additionally or alternatively, the identity similarity may be evaluated based on cosine similarity or Euclidean distance. In this aspect, additionally or alternatively, the method may further comprise inputting test input into the trained first stage model to generate test output, and evaluating the test output of the trained first stage model by calculating at least one image quality metric selected from (a) Peak Signal-to-Noise Ratio (PSNR), (b) Structural Similarity Index (SSIM), or (c) Frechet Inception Distance (FID), and adjusting one or more parameters of the trained first stage model when the at least one image quality metric indicates a reconstruction quality below a predetermined threshold.

Another aspect provides a computing system for training an untrained diffusion model to generate a synthesized image based on an input prompt and an input image, the computing system comprising processing circuitry and memory storing instructions that, when executed, cause the processing circuitry to receive real single-person-single-view (SPSV) images, input each SPSV image into the untrained diffusion model, corrupting the SPSV image through a forward process by adding noise, train the untrained diffusion model in a reverse process to predict a denoised version of the SPSV images and generate reconstructed images by minimizing a loss between the reconstructed images and the SPSV images, adjust weights of the untrained diffusion model based on the minimized loss to generate a trained first stage model, generate synthetic single-person-multi-view (SPMV) images using the trained first stage model, input each SPSV image into the trained first stage model, corrupting the SPSV image through a forward process by adding noise, train the first stage model in a reverse process to predict a denoised version of the SPSV image and generate a reconstructed image, using the synthetic SPMV images as a target image by minimizing a loss between the reconstructed image and the target image, and adjust weights of the first stage model to generate a trained second stage model. In this aspect, additionally or alternatively, generating the synthetic SPMV images may comprise using the trained first stage model and image processing modules to generate a plurality of target images based on the real SPSV images. In this aspect, additionally or alternatively, generating the synthetic SPMV images may comprise using latent space manipulation to synthesize target images with varied poses and expressions. In this aspect, additionally or alternatively, generating the synthetic SPMV images may comprise using face swap techniques to transfer facial identity from the SPSV images to target images with different poses or scenes. In this aspect, additionally or alternatively, generating the synthetic SPMV images may comprise modifying weights of the first stage model using Low-Rank Adaptation (LoRA). In this aspect, additionally or alternatively, the synthetic SPMV images may be paired with corresponding SPSV images to form a dataset. In this aspect, additionally or alternatively, the processing circuitry may be further configured to deploy the trained second stage model to generate synthesized images, wherein the synthesized images maintain identity consistency of the input image while reflecting different poses, expressions, and lighting conditions. In this aspect, additionally or alternatively, the processing circuitry may be further configured to input test input into the trained first stage model to generate test output, evaluate an identity similarity between the test input and the test output, and adjust one or more parameters of the trained first stage model when the identity similarity is below a predetermined threshold. In this aspect, additionally or alternatively, the processing circuitry may be further configured to input test input into the trained first stage model to generate test output, and evaluate the test output of the trained first stage model by calculating at least one image quality metric selected from (a) Peak Signal-to-Noise Ratio (PSNR), (b) Structural Similarity Index (SSIM), or (c) Frechet Inception Distance (FID), and adjust one or more parameters of the trained first stage model when the at least one image quality metric indicates a reconstruction quality below a predetermined threshold.

Another aspect provides a computer-implemented method for generating a synthesized image of a known individual, the method comprising providing a trained diffusion model generated via a multi-stage training process, the multi-stage training process including (i) training a first stage model by minimizing a loss between reconstructed images and real single-person-single-view (SPSV) images, and (ii) training the first stage model against synthetic single-person-multi-view (SPMV) images to produce a second stage model configured to preserve identity consistency under variations in pose, expression, or lighting, receiving, at a computing system, an input image depicting the known individual and an input prompt describing one or more desired attributes of a target image, processing the input image and the input prompt through the trained second stage model to generate the synthesized image such that the synthesized image preserves identity-specific features of the known individual while reflecting the one or more desired attributes of the target image, and outputting the synthesized image.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

It will be appreciated that “and/or” as used herein refers to the logical disjunction operation, and thus A and/or B has the following truth table.

| A | B | A and/or B |
|---|---|---|
| T | T | T |
| T | F | T |
| F | T | T |
| F | F | F |

The subject matter of the present disclosure includes all novel and non-obvious combinations and sub-combinations of the various processes, systems and configurations, and other features, functions, acts, and/or properties disclosed herein, as well as any and all equivalents thereof.

1. A computing method for training an untrained diffusion model to generate a synthesized image based on an input prompt and an input image, comprising:
collecting real single-person-single-view (SPSV) images;
inputting each SPSV image into the untrained diffusion model, corrupting the SPSV image through a forward process by adding noise;
training the untrained diffusion model in a reverse process to predict a denoised version of the SPSV images and generate reconstructed images by minimizing a loss between the reconstructed images and the SPSV images;
adjusting weights of the untrained diffusion model based on the minimized loss to generate a trained first stage model;
generating synthetic single-person-multi-view (SPMV) images using the trained first stage model;
inputting each SPSV image into the trained first stage model, corrupting the SPSV image through a forward process by adding noise;
training the first stage model in a reverse process to predict a denoised version of the SPSV image and generate a reconstructed image, using the synthetic SPMV images as a target image by minimizing a loss between the reconstructed image and the target image; and
adjusting weights of the first stage model to generate a trained second stage model.

2. The computing method of claim 1, wherein generating the synthetic SPMV images comprises using the trained first stage model and image processing modules to generate a plurality of target images based on the real SPSV images.

3. The computing method of claim 2, wherein generating the synthetic SPMV images comprises using latent space manipulation to synthesize target images with varied poses and expressions.

4. The computing method of claim 2, wherein generating the synthetic SPMV images comprises using face swap techniques to transfer facial identity from the SPSV images to target images with different poses or scenes.

5. The computing method of claim 2, wherein generating the synthetic SPMV images comprises modifying weights of the first stage model using Low-Rank Adaptation (LoRA).

6. The computing method of claim 1, wherein the synthetic SPMV images are paired with corresponding SPSV images to form a dataset.

7. The computing method of claim 1, further comprising deploying the trained second stage model to generate synthesized images, wherein the synthesized images maintain identity consistency of the input image while reflecting different poses, expressions, and lighting conditions.

8. The computing method of claim 1, further comprising:
inputting test input into the trained first stage model to generate test output;
evaluating an identity similarity between the test input and the test output; and
adjusting one or more parameters of the trained first stage model when the identity similarity is below a predetermined threshold.

9. The computing method of claim 8, wherein the identity similarity is evaluated based on cosine similarity or Euclidean distance.

10. The computing method of claim 1, further comprising:
inputting test input into the trained first stage model to generate test output; and
evaluating the test output of the trained first stage model by calculating at least one image quality metric selected from:
(a) Peak Signal-to-Noise Ratio (PSNR),
(b) Structural Similarity Index (SSIM), or (c) Frechet Inception Distance (FID); and
adjusting one or more parameters of the trained first stage model when the at least one image quality metric indicates a reconstruction quality below a predetermined threshold.

11. A computing system for training an untrained diffusion model to generate a synthesized image based on an input prompt and an input image, the computing system comprising:
processing circuitry and memory storing instructions that, when executed, cause the processing circuitry to:
receive real single-person-single-view (SPSV) images;
input each SPSV image into the untrained diffusion model, corrupting the SPSV image through a forward process by adding noise;
train the untrained diffusion model in a reverse process to predict a denoised version of the SPSV images and generate reconstructed images by minimizing a loss between the reconstructed images and the SPSV images;
adjust weights of the untrained diffusion model based on the minimized loss to generate a trained first stage model;
generate synthetic single-person-multi-view (SPMV) images using the trained first stage model;
input each SPSV image into the trained first stage model, corrupting the SPSV image through a forward process by adding noise;
train the first stage model in a reverse process to predict a denoised version of the SPSV image and generate a reconstructed image, using the synthetic SPMV images as a target image by minimizing a loss between the reconstructed image and the target image; and
adjust weights of the first stage model to generate a trained second stage model.

12. The computing system of claim 11, wherein generating the synthetic SPMV images comprises using the trained first stage model and image processing modules to generate a plurality of target images based on the real SPSV images.

13. The computing system of claim 12, wherein generating the synthetic SPMV images comprises using latent space manipulation to synthesize target images with varied poses and expressions.

14. The computing system of claim 12, wherein generating the synthetic SPMV images comprises using face swap techniques to transfer facial identity from the SPSV images to target images with different poses or scenes.

15. The computing system of claim 12, wherein generating the synthetic SPMV images comprises modifying weights of the first stage model using Low-Rank Adaptation (LoRA).

16. The computing system of claim 11, wherein the synthetic SPMV images are paired with corresponding SPSV images to form a dataset.

17. The computing system of claim 11, wherein the processing circuitry is further configured to deploy the trained second stage model to generate synthesized images, wherein the synthesized images maintain identity consistency of the input image while reflecting different poses, expressions, and lighting conditions.

18. The computing system of claim 11, the processing circuitry is further configured to:
input test input into the trained first stage model to generate test output;
evaluate an identity similarity between the test input and the test output; and
adjust one or more parameters of the trained first stage model when the identity similarity is below a predetermined threshold.

19. The computing system of claim 11, the processing circuitry is further configured to:
input test input into the trained first stage model to generate test output; and
evaluate the test output of the trained first stage model by calculating at least one image quality metric selected from:
(a) Peak Signal-to-Noise Ratio (PSNR),
(b) Structural Similarity Index (SSIM), or
(c) Frechet Inception Distance (FID); and
adjust one or more parameters of the trained first stage model when the at least one image quality metric indicates a reconstruction quality below a predetermined threshold.

20. A computer-implemented method for generating a synthesized image of a known individual, the method comprising:
providing a trained diffusion model generated via a multi-stage training process, the multi-stage training process including:
(i) training a first stage model by minimizing a loss between reconstructed images and real single-person-single-view (SPSV) images; and
(ii) training the first stage model against synthetic single-person-multi-view (SPMV) images to produce a second stage model configured to preserve identity consistency under variations in pose, expression, or lighting;
receiving, at a computing system, an input image depicting the known individual and an input prompt describing one or more desired attributes of a target image;
processing the input image and the input prompt through the trained second stage model to generate the synthesized image such that the synthesized image preserves identity-specific features of the known individual while reflecting the one or more desired attributes of the target image; and
outputting the synthesized image.
